(19) United States
(12) Patent Application Publication
(10) Pub. No.: US 2013/0065151 A1
(43) Pub. Date: Mar. 14, 2013

(54) FUEL CELL AND ELECTRODE FOR FUEL CELL, AND ELECTRONIC DEVICE

(71) Applicant: Kengo Makita, Kanagawa (JP)

(72) Inventor: Kengo Makita, Kanagawa (JP)

(73) Assignee: Sony Corporation, Tokyo (JP)

(21) Appl. No.: 13/126,123

(22) PCT Filed: Oct. 29, 2009
(86) PCT No.: PCT/JP2009/068583

§ 371 Date: Apr. 26, 2011

(30) Foreign Application Priority Data
Oct. 31, 2008 (JP) 2008-281347

(51) Int. Cl. H01M 8/02; H01M 8/24

(52) U.S. Cl. 429/454; 429/505

(57) ABSTRACT

In one example embodiment, an electronic device uses a fuel cell which reduces thickness of the overall fuel cell while reducing electrical resistance. In one example embodiment, a flow path that distributes an electrolyte is included between a fuel electrode and an oxygen electrode. In one example embodiment, a current collector on the fuel electrode side has a pair of current collector terminals in opposing-corner positions. Similarly, a current collector on the oxygen electrode side has a pair of current collector terminals in opposing-corner positions. The current collector terminals project outside the fuel cell. Thereby, connection of unit cells within the battery is facilitated, a monopolar plate structure becomes easier to use as the current collector, and distance of flowing current is shortened.

### CROSS REFERENCE TO RELATED APPLICATIONS

The present application is a National Stage of International Application No. PCT/JP2009/068583 filed on Oct. 29, 2009, which claims priority to Japanese Patent Application No. 2008-281347 filed on Oct. 31, 2008, the entire contents of which are being incorporated herein by reference.

### BACKGROUND

In recent years, as mobile devices become more high performance, power consumption has been increasing. Fuel cells are being regarded most likely as a battery replacing the lithium ion secondary battery. The fuel cells are classified into AFC (Alkaline Fuel Cell), PAFC (Phosphoric Acid Fuel Cell), MCFC (Molten Carbonate Fuel Cell), SOFC (Solid Electrolyte Fuel Cell), PEFC (Polymer Electrolyte Fuel Cell), and the like, depending on an electrolyte.

As fuel of the fuel cell, various combustible substances, such as hydrogen and methanol, are able to be used. However, gaseous fuels, such as hydrogen, are not suitable for downsizing because a cylinder for storage or the like is needed. Meanwhile, liquid fuels, such as methanol, are advantageous in terms of being easy to store. In particular, the DMFC has advantages in that a reformer for extracting hydrogen from the fuel is not needed, the structure becomes simple, and downsizing is facilitated.

Energy density of methanol that is the fuel in the DMFC is theoretically 4.8 kW/L and is ten times the energy density of a typical lithium ion secondary battery or more. That is, the fuel cell using methanol as fuel has a high possibility of surpassing the energy density of the lithium ion secondary battery. From the foregoing, among the various fuel cells, the DMFC is very likely to be used as an energy source for mobile devices and electric vehicles.

However, the DMFC has a shortcoming in that, regardless of the theoretical voltage being 1.23 V, the output voltage during actual power generation decreases to about 0.6 V or lower. A reason for the decrease in the output voltage is voltage drop caused by internal resistance in the DMFC. In the DMFC, internal resistance, such as resistance associated with reaction generated at both electrodes, resistance associated with movement of substances, resistance generated when protons move in an electrolyte film and, further, contact resistance and the like, is present. Energy that is actually able to be extracted as electrical energy from oxidation of methanol is expressed by a product of the output voltage during power generation and the quantity of electricity flowing through a circuit. Thus, if the output voltage during power generation decreases, the energy that is actually able to be extracted also decreases.

Meanwhile, in such a DMFC, a DMFC is being developed that reduces internal resistance by using liquid electrolyte (electrolytic solution) instead of the electrolyte film. However, a common shortcoming among fuel cells using liquid electrolyte and solid electrolyte is that the voltage of a single fuel cell is extremely low and clearly insufficient for extracting substantial current. Thus, to make the voltage usable, proposed is a fuel cell in which a fuel cell stack structure is formed by connecting a large number of fuel cells in series (may be connected in parallel after being connected in series), and a current collector is provided for efficiently converting voltage to electrical energy (for example, Patent Document 1).

### CITATION LIST

### Patent Document

Patent document 1: Japanese Unexamined Patent Application Publication No. 2007-280678

### SUMMARY

The present disclosure relates to a fuel cell, such as a DMFC (Direct Methanol Fuel Cell), that supplies methanol to a fuel electrode and causes reaction, an electrode used in the fuel cell, and an electronic device including the fuel cell.

However, in the method of making the voltage usable by forming the fuel cell stack structure, various issues are inevitably present because the number of sheets of fuel cells increases. For example, there are issues regarding thickness, issues regarding weight, issues regarding electrical resistance, problems regarding cost, and issues regarding material selection.

Currently, as the current collector and a bonding means of the fuel cell stack, there is a bipolar plate. Functions of the bipolar plate that are most used are as follows. That is, the functions are: (a) a function for uniformly supplying fuel fluid and oxidation fluid into a battery face; (b) a function for efficiently discharging water generated on the air electrode side with air after reaction from inside the fuel cell to outside the system; (c) a function as an electrical connector (current collector) between unit cells that maintain low electrical resistance and favorable conductivity as an electrode over a long period; (d) a function as a partition wall between an anode chamber of one cell and a cathode chamber of an adjacent cell, in adjacent cells; and (e) a function as a partition wall between a coolant flow path and an adjacent cell.

As in the foregoing, the bipolar plate bonds the overall surface of a fuel electrode with an air electrode of an adjacent fuel cell, and is able to integrate the fuel electrode to an oxygen electrode of an adjacent fuel cell. It is clear from the foregoing that the structure is the structure in which the current efficiently passes perpendicular to the fuel cells rather than over each electrode surface.

However, various issues are present in the bipolar plate structure as well. For example, because the current passes perpendicularly between the fuel cells, an electrical contact section needs to be made as large as possible. In this case, a shortcoming occurs in that the flow of fuel and air (oxygen) is blocked. Thus, if the electrical contact section is made small so as not to block the flow of fuel and air (oxygen), the number of contact sections needs to be increased to reduce electrical resistance. However, this causes the manufacturing procedure to become complicated and the manufacturing cost to increase, and a shortcoming occurs regarding the strength of the bipolar plate, as well.

In addition, the thickness of the fuel cell and the thickness of the fuel cell stack are dependent on the thickness of the bipolar plate. Generally, a flow path for the fuel electrode and a flow path for the oxygen electrode need to be formed in the bipolar plate. Thus, it is very difficult to significantly reduce the thickness of the stack. Further, a limit to the thickness is set by the materials being used.

Moreover, although a method for stacking the plurality of fuel cells by applying pressure is used, it is difficult to apply uniform pressure to the overall fuel cell, and distortion occurs in the flow paths for the fuel electrode and the oxygen electrode. Thus, the solid electrolyte (electrolyte film) is used as the electrolyte.

Thus, it is very difficult to reduce the thickness of the fuel cell stack while reducing electrical resistance using the bipolar plate, due to a trade-off relationship such as the foregoing.

As a method for solving such disadvantages of the bipolar plate, using a monopolar plate may be considered. A method of bonding a fuel cell stack using the monopolar plate is very simple. That is, an end portion of an oxygen electrode is simply bonded to an adjacent fuel electrode by an electric wire, by welding, or the like. Thus, liquid electrolyte is able to be used, thereby internal resistance within the fuel is able to be reduced, and the thickness of the fuel cell is able to be reduced by supplying the electrolyte and the fuel using the same flow path.

Further, unlike the bipolar plate, the current does not flow perpendicularly to the fuel cells, but rather traverses the surface of the electrode and flows to the current collector at the end. Thus, the trade-off relationship between the electrical contact section and the fuel and air (oxygen) fluids is dissolved.

Further, the supply flow path for fluids, such as fuel and air (oxygen), is not necessarily be formed on the plate. Thus, there is flexibility in selection of the plate material, and a very thin plate is able to be used, thereby the thickness of the fuel cell stack is able to be significantly reduced.

However, as described above, since the current is necessary to traverse the surface of the electrode or the plate and flow to the current collector at the end, the electrode and the plate need to be very good conductors. Therefore, in the case where operating current is low, shortcomings do not occur; however, the electrical resistance of the monopolar plate becomes an issue in fuel cells and fuel cell stacks having very high operating current.

The present disclosure has been achieved in light of the foregoing issues. A first object of the present invention is to provide a fuel cell capable of realizing reduced thickness of the overall fuel cell while reducing electrical resistance, and an electronic device using the fuel cell.

A second object of the present disclosure is to provide an electrode capable of being favorably used as a fuel electrode and an oxygen electrode of the foregoing fuel cell.

A fuel cell according to an example embodiment of the present disclosure includes: a fuel electrode including a first current collector; an oxygen electrode including a second current collector; an electrolyte flow path that is provided between the fuel electrode and the oxygen electrode, and distributes at least an electrolyte; and a plurality of current collector terminals that are provided in at least one of the first current collector and the second current collector, and project outside.

An electrode according to an example embodiment of the present disclosure is used as an electrode of the foregoing fuel electrode or an electrode of the foregoing oxygen electrode, and has a plurality of current collector terminals in a current collector.

An electronic device according to an example embodiment of the present disclosure includes the foregoing fuel cell.

In the fuel cell, the electrode, and the electronic device according to an example embodiment of the present disclosure, since the current collector terminals of the current collector project outside the battery, connection between unit cells within the battery is facilitated, and a monopolar plate structure becomes easier to use as the current collector. Thereby, a distributable substance is able to be used as an electrolyte and, for example, the electrolyte and a fuel are able to be supplied over the same flow path. In addition, since a plurality of current collector terminals are provided in each current collector, compared to a case where only a single current collector terminal is provided in the current collector as in the past, distance of a current flowing when the monopolar plate structure is used is shortened.

According to the fuel cell, the electrode, and the electronic device according to an example embodiment of the present disclosure, since the current collector terminals of the current collector project outside the battery, the monopolar plate structure becomes easier to use as the current collector. Further, a distributable substance is able to be used as the electrolyte, and the thickness of the overall fuel cell is able to be reduced. In addition, since a plurality of current collector terminals are provided in each current collector, in the case where the monopolar plate structure is used, the distance over which the current flows is able to be shortened, compared to that in the past. In the result, reduced thickness of the overall fuel cell is able to be realized while reducing electrical resistance.

Additional features and advantages are described herein, and will be apparent from the following Detailed Description and the figures.

### BRIEF DESCRIPTION OF THE FIGURES

FIG. 1 is a cross sectional view illustrating a structure of a fuel cell according to an example embodiment of the present disclosure.

FIG. 2 is a plan view illustrating a structure of a current collector illustrated in FIG. 1, a stacking method of the current collector, and a flow path over which a current flows.

FIG. 3 is a plan view illustrating a structure of a current collector in related art, a stacking method thereof, and a flow path over which a current flows.

FIG. 4 is diagram illustrating a schematic structure of a fuel cell system.

FIG. 5 is a characteristics diagram illustrating an example of a relationship between resistance and length of a metal mesh.

FIG. 6 is a characteristics diagram for explaining differences depending on the number of terminals of the current collector.

FIG. 7 is a plan view of a modified example of the current collector.

### DETAILED DESCRIPTION

An example embodiment of the present disclosure will be hereinafter described in detail with reference to the drawings.

### Structural Example of Fuel Cell

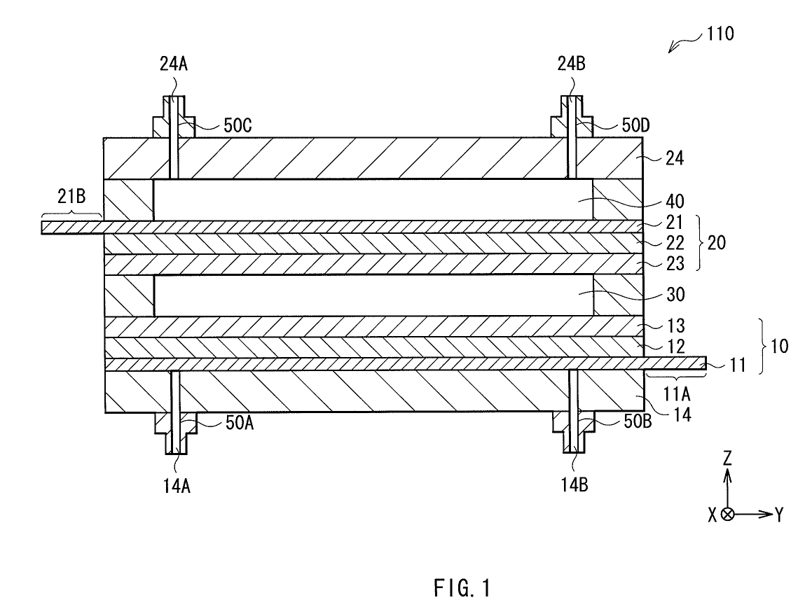

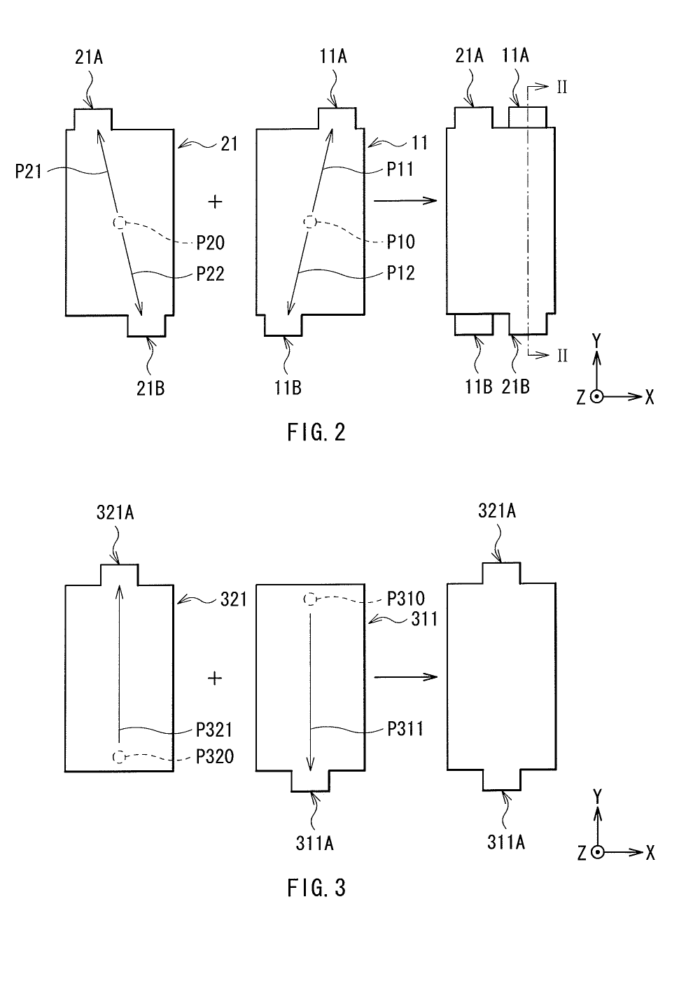

FIG. 1 illustrates a cross sectional structure (YZ cross sectional structure) of a fuel cell 110 according to an example embodiment of the present disclosure. FIG. 1 corresponds to a cross sectional structure taken along line II-II in FIG. 2. The fuel cell 110 is a so-called DMFFC (Direct Methanol Flow Based Fuel Cell), and has a structure in which a fuel electrode 10 and an oxygen electrode 20 oppositely arranged. Between the fuel electrode 10 and the oxygen electrode 20, a fuel/electrolyte flow path 30 is provided for distributing a fuel/electrolyte mixture.

The fuel electrode 10 is formed by a diffusion layer 12 and a catalyst layer 13 being layered in this order on a current collector 11 (first current collector). Meanwhile, the oxygen electrode 20 has a structure in which a diffusion layer 22 and a catalyst layer 23 are stacked in this order on a current collector 21 (second current collector). The catalyst layer 13 and the catalyst layer 23 face the fuel/electrolyte flow path 30.

The current collector 11 is composed of, for example, a porous material or a plate-shaped member having electrical conductivity; specifically a titanium (ti) mesh, a titanium plate, or the like. The current collector 21 is similarly composed of, for example, a titanium mesh, a titanium plate, or the like. The material of the current collector is not limited to titanium, and other metals may be used. In addition, the current collector may be the current collector on which surface treatment is performed.

FIG. 2 illustrates the shapes of the current collector 11 and the current collector 21 structuring the fuel cell 110, and a stacking method thereof.

As shown in FIG. 2, the current collector 11 and the current collector 21 have a rectangular shape and each have two current collector terminals. Current collector terminals 11A and 11B of the current collector 11, and current collector terminals 21A and 21B of the current collector 21 are provided along an X axis so as to project along Y axis directions to outside the fuel cell. Each current collector terminal is disposed in opposing corners. Further, the current collector terminal 11A and the current collector terminal 21A, and the current collector terminal 11B and the current collector terminal 21B are disposed so as not to overlap with each other when the current collectors 11 and 21 are stacked in a Z axis direction. In addition, in the case where a plurality of unit cells are stacked, in order to facilitate connection between unit cells, for example, the unit cells are stacked so that the current collector terminal provided in the fuel electrode of one unit cell overlaps the current collector terminal provided in the oxygen electrode of another adjacent unit cell.

The diffusion layers 12 and 22 are composed of, for example, carbon cloth, carbon paper, or carbon sheet. Water-proofing treatment is preferably performed on the diffusion layers 12 and 22 by polytetrafluoroethylene (PTFE) or the like. However, the diffusion layers 12 and 22 are not necessarily provided, and the catalyst layer may be formed directly on the current collector.

The catalyst layers 13 and 23 are composed of, for example, a simple substance or an alloy of a metal, such as palladium (Pd), platinum (Pt), iridium (Ir), rhodium (Rh), or ruthenium (Ru), an organic complex, an enzyme, or the like that has a nature of oxidizing as a catalyst.

In addition to the foregoing catalyst, the catalyst layers 13 and 23 may contain a proton conductor and a binder. Examples of the proton conductor include the foregoing polyperfluoroalkyl sulfonic acid resin (“Nafion (registered trademark)”, manufactured by DuPont) or other resins having proton conductivity. The binder is added to retain strength and flexibility of the catalyst layers 13 and 23. Examples of the binder include resins such as polytetrafluoroethylene (PTFE) and polyvinylidene fluoride (PVDF).

On the outer side of the fuel electrode 10 and the oxygen electrode 20, package members 14 and 24 are respectively provided. The package members 14 and 24 have, for example, a thickness of 1 mm, and are composed of a commonly available material such as a metal plate, such as a titanium (Ti) plate, or a resin plate. However, the material is not particularly limited. In addition, the thickness of the package members 14 and 24 is preferably as thin as possible.

The fuel/electrolyte flow path 30 is, for example, the fuel/electrolyte flow path in which a fine flow path is formed by processing a resin sheet, and is bonded to both sides of the fuel electrode 10 opposing the oxygen electrode 20. The fuel/electrolyte flow path 30 is intended to be supplied a fluid F1 containing fuel and electrolyte, such as a methanol-sulfuric acid mixture, from a fuel/electrolyte inlet 14A and a fuel/electrolyte outlet 14B provided in the package member 14, through a through-hole 50A and a through-hole 50B. The number of flow paths and the shape thereof are not limited, and a serpentine shape or a parallel arrangement may be used. Further, the width, the height, and the length of the flow path are not particularly limited, though they are preferably small. Within the fuel/electrolyte flow path 30, the fuel and the electrolyte may be distributed in a mixed state, or may be distributed in a state in which the fuel and the electrolyte are isolated.

On the side opposite to the fuel/electrolyte flow path 30 (outer side) of the oxygen electrode 20, an air flow path 40 is provided for supplying air or oxygen. The air flow path 40 is intended to be supplied air by natural ventilation or a forcible supplying method, such as a fan, a pump, or a blower, from an air inlet 24A and an air outlet 24B provided in the package member 24, through a through-hole 50C and a through-hole 50D. As is that of the fuel/electrolyte flow path 30, the structure of the air flow path 40 is also not limited.

The foregoing fuel cell is able to be manufactured, for example, as follows.

### Example of Method of Manufacturing Fuel Cell

First, for example, an alloy containing a given ratio of platinum (Pt) and ruthenium (Ru), as a catalyst, and a dispersion solution of polyperfluoroalkyl sulfonic acid resin (“Nafion (registered trademark)”, manufactured by DuPont) are mixed with a given ratio, and thereby the catalyst layer 13 of the fuel electrode 10 is formed. The catalyst layer 13 is thermocompression-bonded to the diffusion layer 12 composed of the foregoing material. Next, the diffusion layer 12 and the catalyst layer 13 are thermocompression-bonded to one surface of the current collector 11 composed of the foregoing material using a hot-melt-type adhesive or an adhesive resin sheet, and thereby the fuel electrode 10 is formed. In addition, the catalyst layer 13 may be directly formed on the current collector 11 without forming the diffusion layer 12, as described above.

Further, platinum (Pt) held on carbon as a catalyst, and a disperse solution of polyperfluoroalkyl sulfonic acid resin (“Nafion (registered trademark),” manufactured by DuPont) are mixed with a given ratio, and thereby the catalyst layer 23 of the oxygen electrode 20 is formed. The catalyst layer 23 is thermocompression-bonded to the diffusion layer 22 composed of the foregoing material. Next, the current collector 21 composed of the foregoing material is set to form the arrangement of the current collector terminals illustrated in FIG. 2, and is thermocompression-bonded using a hot-melt-type adhesive or an adhesive resin sheet, and thereby the oxygen electrode 20 is formed.

Next, an adhesive resin sheet is prepared and a flow path is formed on the resin sheet. Thereby, the fuel/electrolyte flow path 30 is formed and is thermocompression-bonded to a surface of the fuel electrode 10 opposing the oxygen electrode 20.

Next, the package members 14 and 24 composed of the foregoing material are formed. The fuel/electrolyte inlet 14A and the fuel/electrolyte outlet 14B composed of, for example, resin joints are provided in the package member 14, and the air inlet 24A and the air outlet 24B composed of, for example, resin joints are provided in the package member 24.

Then, the oxygen electrode 20 is bonded to the thermocompression-bonded fuel/electrolyte flow path 30, and contained in the package members 14 and 24. In the result, the fuel cell 110 illustrated in FIG. 1 and FIG. 2 is completed.

Next, operation and effect of the foregoing fuel cell 110 will be described.

In the fuel cell 110, when the fuel and the electrolyte are supplied to the fuel electrode 10 by the fuel/electrolyte flow path 30, protons and electrons are generated by reaction. The protons move through the fuel/electrolyte flow path 30 to the oxygen electrode 20, and generate water by reacting with the electrons and oxygen. The reactions occurring in the fuel electrode 10, the oxygen electrode 20, and the overall fuel cell 110 are expressed in Formulas 1 to 3. Thereby, a part of the chemical energy of methanol as a fuel is converted to electrical energy and extracted as electric power. In addition, carbon dioxide generated in the fuel electrode 10 and water generated in the oxygen electrode 20 flow to the fuel/electrolyte flow path 30 and are removed.

Fuel electrode 10: CH₃OH+H₂O→CO₂+6e⁻+6H⁺ (1)

Oxygen electrode 20: (3/2)O₂+6e⁻+6H⁺→3H₂O (2)

Overall fuel cell 110: CH₃OH+(3/2)O₂→CO₂+2H₂O (3)

According to the present example embodiment, since the current collector terminals 11A and 11B of the current collector 11 and the current collector terminals 21A and 21B of the current collector 21 project outside of the fuel cell, the fuel electrode and the oxygen electrode between unit cells are able to be connected using a simple method, such as electric wires or welding. Thus, a monopolar plate structure is able to be easily used as the current collector. In the result, a distributable substance (electrolytic liquid) is able to be used as the electrolyte, and, for example, the electrolyte and the fuel are able to be supplied by the same flow path. In addition, since a plurality of current collector terminals are provided in each current collector, compared to a case where only one current collector terminal is provided in the current collector as in the past, the distance over which the current flows when the monopolar plate is used is shortened.

FIG. 3 illustrates the shape of a current collector 311 and a current collector 321 used in a fuel cell of related art and a stacking method thereof as a comparison example. A current collector terminal 311A and a current collector 321A are respectively provided in the current collectors 311 and 321. In the fuel cell using such current collectors, for example, the current (P310 and P320) generated in the locations illustrated in FIG. 3 need to traverse the surface of the electrode or the plate (P321 and P311) and flow to the current collector (current collector terminals) at the end. Therefore, high resistance is applied inside the fuel cell.

Meanwhile, in the current collector 11 and the current collector 21 according to the present example embodiment, as a result of two current collectors 11A and 11B, and 21A and 21B being respectively disposed in the current collector 11 and the current collector 21 in opposing corners, the distance over which the current (P10 and P20) generated as illustrated in FIG. 2 flows over the electrode surface is halved (P11, P12, and P21 and P22). As a result, the electrical resistance of the electrode itself is significantly reduced.

As described above, according to the present example embodiment, since the current collector terminals of the current collectors project outside the battery, the monopolar plate structure is able to be easily used as the current collector, and a distributable electrolyte, that is electrolytic liquid, is able to be used. Thus, the thickness of the overall fuel cell is able to be reduced. In addition, since a plurality of current collector terminals are provided in each current collector, in the case where the monopolar plate structure is used, the distance over which the current flows is able to be shortened compared to that in the past. In the result, reduced thickness of the overall fuel cell is able to be realized while reducing electrical resistance.

In addition, as a result of the fuel and the electrolyte being supplied as a fluid, the electrolyte film is no longer necessary, and power generation is able to be performed without being affected by temperature and humidity. In addition, ion conductivity (proton conductivity) is able to be enhanced compared to a typical fuel cell using the electrolyte film. Further, risk of deterioration of the electrolyte film and reduction of proton conductivity due to drying of the electrolyte film is eliminated, and issues regarding flooding and moisture control in the oxygen electrode are also solved.

In addition, since each fuel cell is able to be sealed, handing during manufacture of the fuel cell stack is facilitated.

Further, high output is able to be realized with a highly flexible and simple structure that is capable of being mounted in mobile devices to large-scale devices. Thus, in particular, the fuel cell is able to be favorably used in a multifunctional high-performance electronic device that is thin and has high power consumption.

Next, an application example of the foregoing fuel cell 110 will be described.

### Application Example

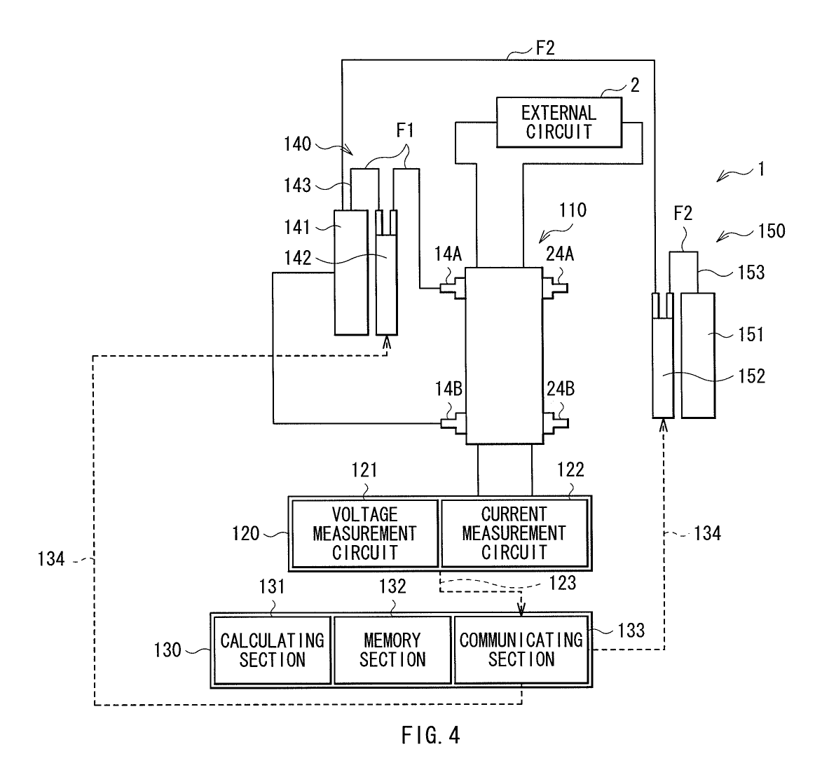

FIG. 4 illustrates a schematic structure of an electronic device having a fuel cell system including the fuel cell 110 of the present disclosure. The electronic device is, for example, a mobile device, such as mobile phone or a personal digital assistant (PDA), or a notebook personal computer (PC), and includes a fuel cell system 1 and an external circuit (load) 2 driven by electrical energy generated by the fuel cell system 1.

The fuel cell system 1 includes, for example, the fuel cell 110, a measuring section 120 that measures an operating state of the fuel cell 110, and a control section 130 that decides the operating conditions of the fuel cell 110 based on measurement results from the measuring section 120. The fuel cell system 1 also includes a fuel/electrolyte supplying section 140 that supplies the fluid F1 containing the fuel and the electrolyte to the fuel cell 110, and a fuel supplying section 150 that supplies only a fuel F2, such as methanol, to a fuel/electrolyte storage section 141. In addition, the fuel/electrolyte flow path 30 in the fuel cell 110 is connected to the fuel/electrolyte supplying section 140 by the fuel/electrolyte inlet 14A and the fuel/electrolyte outlet 14B provided in the package member 14, and the fluid F1 is supplied from the fuel/electrolyte supplying section 140.

The measuring section 120 measures the operating voltage and the operating current of the fuel cell 110, and for example, has a voltage measurement circuit 121 that measures the operating voltage of the fuel cell 110, a current measurement circuit 122 that measures the operating current, and a communication line 123 used to send the obtained measurement results to the control section 130.

The control section 130 exercises control of fuel-electrolyte supply parameters and fuel supply parameters as the operating conditions of the fuel cell 110 based on the measurement results of the measuring section 120, and has, for example, a calculating section 131, a memory section 132, a communicating section 133, and a communication line 134. Here, the fuel/electrolyte supply parameters include, for example, a supply flow rate of the fluid F1 containing the fuel and the electrolyte. The fuel supply parameters include, for example, a supply flow rate and a supply amount of the fuel F2, and may include a supply concentration according to needs. The control section 130 is able to be structured by, for example, a microcomputer.

The calculating section 131 calculates the output of the fuel cell 110 from the measurement results obtained in the measuring section 120 and sets the fuel/electrolyte supply parameters and the fuel supply parameters. Specifically, the calculating section 131 averages anode potentials, cathode potentials, output voltages, and output currents sampled at a constant interval from various measurement results inputted into the memory section 132, calculates an average anode potential, an average cathode potential, an average output voltage, and an average output current, and inputs the calculated averages in the memory section 132. The calculating section 131 then performs cross comparison of the various average values stored in the memory section 132, and determines the fuel/electrolyte supply parameters and the fuel supply parameters.

The memory section 132 stores therein various measurement values sent from the measuring section 120, various average values calculated by the calculating section 131, and the like.

The communicating section 133 has a function for receiving the measurement results from the measuring section 120 over the communication line 123, and inputting the measurement results in the memory section 132; and a function for respectively outputting signals for setting the fuel/electrolyte supply parameters and the fuel supply parameters to the fuel/electrolyte supplying section 140 and the fuel supplying section 150 over the communication line 134.

The fuel/electrolyte supplying section 140 includes a fuel/electrolyte storage section 141, a fuel/electrolyte supply adjusting section 142, and a fuel/electrolyte supply line 143. The fuel/electrolyte storage section 141 stores the fluid F1, and is structured by, for example, a tank or a cartridge. The fuel/electrolyte supply adjusting section 142 adjusts the supply flow rate of the fluid F1. The fuel/electrolyte supply adjusting section 142 is not particularly limited as long as it is able to be driven by signals from the control section 130, but is preferably structured by, for example, a valve driven by a motor or a piezoelectric element, or an electromagnetic pump.

The fuel supplying section 150 has a fuel storage section 151, a fuel supply adjusting section 152, and a fuel supply line 153. The fuel storage section 151 stores only the fuel F2, such as methanol, and is structured by, for example, a tank or a cartridge. The fuel supply adjusting section 152 adjusts the supply flow rate and the supply amount of the fuel F2. The fuel supply adjusting section 152 is not particularly limited as long as it is able to be driven by signals from the control section 130, and is preferably structured by, for example, a valve driven by a motor or a piezoelectric element, or an electromagnetic pump. In addition, the fuel supplying section 150 may include a concentration adjusting section (not shown) that adjusts the supply concentration of the fuel F2. The concentration adjusting section is able to be omitted if pure (99.9%) methanol is used as the fuel F2, and further size reduction is able to be achieved.

The foregoing fuel cell system 1 is able to be manufactured as follows.

### Example of Method of Manufacturing Fuel Cell System

For example, the foregoing fuel cell 110 is mounted in a system including the measuring section 120, the control section 130, the fuel/electrolyte supplying section 140, and the fuel supplying section 150 having the foregoing structures. The fuel inlet 14A and the fuel outlet 14B are connected to the fuel supplying section 150 by the fuel supply line 153 composed of for example, a silicone tube. In addition, the fuel/electrolyte inlet 14A and the fuel/electrolyte outlet 14B are connected to the fuel/electrolyte supplying section 140 by the fuel/electrolyte supply line 140 composed of for example, a silicone tube. Thereby, the fuel cell system 1 illustrated in FIG. 4 is completed.

In such a fuel cell system 1, in the case where the fluid F1 containing the fuel and the electrolyte is supplied from the fuel/electrolyte supplying section 140 to the fuel cell 110, electric power is extracted from the fuel cell 110 and the external circuit 2 is driven. During operation of the fuel cell 110, the operating voltage and the operating current of the fuel cell 110 are measured by the measuring section 120, and the control section 130 exercises control of the foregoing fuel/electrolyte supply parameters, and the fuel supply parameters as the operating conditions of the fuel cell 110, based on the measurement results. Measurement by the measuring section 120 and parameter control by the control section 130 are frequently repeated, and the supply states of the fluid F1 and the fuel F2 are optimized such as to follow property variations of the fuel cell 110.

Next, an example illustrating the effects of the foregoing fuel cell 110 and the fuel cell system 1 including the fuel cell 110 will be described.

### Example

In the foregoing manufacturing method, an alloy containing a given ratio of platinum (Pt) and ruthenium (Ru), as the catalyst, and the disperse solution of polyperfluoroalkyl sulfonic acid resin (“Nafion (registered trademark)”, manufactured by DuPont) are mixed with a given ratio, and thereby the catalyst layer 13 of the fuel electrode 10 was formed. The catalyst layer 13 was thermocompression-bonded for ten minutes to the diffusion layer 12 (HT-2500; manufactured by E-TEK) composed of the foregoing material, under conditions of a temperature of 150 deg C. and pressure of 249 kPa. Further, the current collector 11 composed of the foregoing material was thermocompression-bonded using a hot-melt-type adhesive or an adhesive resin sheet, and thereby the fuel electrode 10 was formed. The current collector 11 used herein has a shape such as the shape illustrated in FIG. 2, and has two current collector terminals each of which is disposed in opposing corners.

In addition, platinum (Pt) held on carbon, as a catalyst, and the disperse solution of polyperfluoroalkyl sulfonic acid resin (“Nafion (registered trademark)”, manufactured by DuPont) were mixed with a given ratio, and thereby the catalyst layer 23 of the oxygen electrode 20 was formed. The catalyst layer 23 was thermocompression-bonded to the diffusion layer 22 (HT-2500; manufactured by E-TEK) composed of the foregoing material in a manner similar to the catalyst layer 13 of the fuel electrode 10. Further, the current collector 21 composed of the foregoing material was thermocompression-bonded in a manner similar to the current collector 11 of the fuel electrode 10, and thereby the oxygen electrode 20 was formed. The current collector 21 used herein also has the shape illustrated in FIG. 2 and has two current collector terminals each of which is disposed in opposing corners, as does the current collector 11.

Next, an adhesive resin sheet was prepared, the flow path was formed on the resin sheet, and the resin sheet was thermocompression-bonded between the fuel electrode 10 and the oxygen electrode 20. Subsequently, the package members 14 and 24 composed of the foregoing material were formed. The fuel/electrolyte inlet 14A and the fuel/electrolyte outlet 14B composed of, for example, a resin joint, were provided in the package member 14, and the air inlet 24A and the air outlet 24A composed of, for example, a resin joint, were provided in the package member 24. Then, the fuel electrode 10 and the oxygen electrode 20 were contained within the package members 14 and 24, with the fuel/electrode flow path 30 disposed therebetween.

The fuel cell 110 was mounted in the system including the measuring section 120, the control section 130, the electrolyte supplying section 140, and the fuel supplying section 150, having the foregoing structures, and thereby the fuel cell system 1 illustrated in FIG. 4 was structured. At this time, the fuel/electrolyte supply adjusting section 142 and the fuel supply adjusting section 152 were configured by a diaphragm pump (manufactured by KNF). From each pump, the fuel/electrolyte supply line 143 composed of a silicone tube was directly connected to the fuel/electrolyte inlet 14A, and the fuel supply line 153 was directly connected to the fuel/electrolyte storage section, and an arbitrary amount of methanol was supplied so that the methanol content within the fuel/electrolyte storage section was 1M at all times. As the electrolyte of the fluid F2, a mixture of 1M of methanol and 1M of sulfur was used, and supplied to the fuel cell 110 at a flow rate of 1.0 ml/min.

### Evaluation

The effects of the obtained fuel cell system 1 were studied using the current collectors each having two current collector terminals in the fuel electrode and the oxygen electrode. As a comparison example, a similar experiment was performed using a fuel cell including the current collectors (FIG. 3) each having one current collector terminal in the fuel electrode and the oxygen electrode.

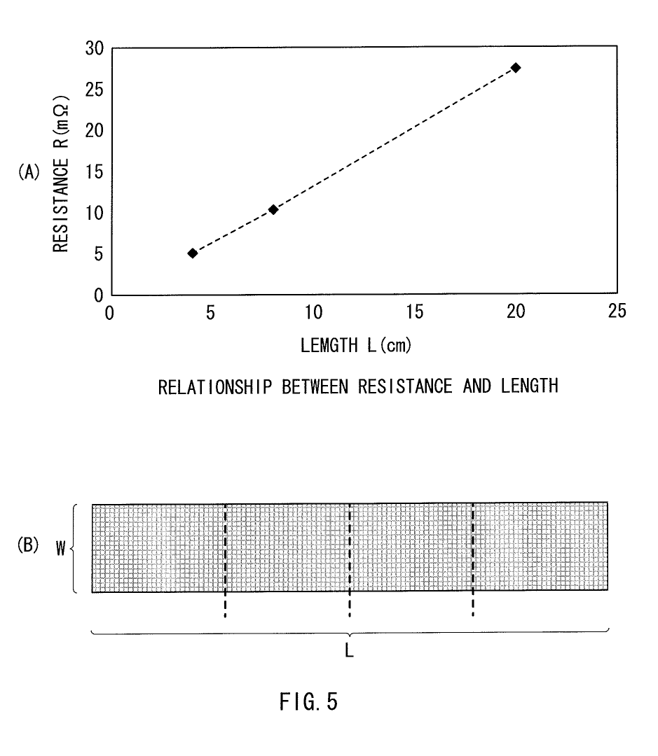

First, FIG. 5 illustrates the results of resistance measurement respectively taken at 4 cm, 8 cm, and 20 cm points, using a titanium mesh having a thickness of 200 μm and a width of 4.0 cm. It is clear from the graph in FIG. 5 that the resistance and the length (distance) have a proportional relationship, and as the distance over which electricity flows increases, resistance inevitably tends to increase.

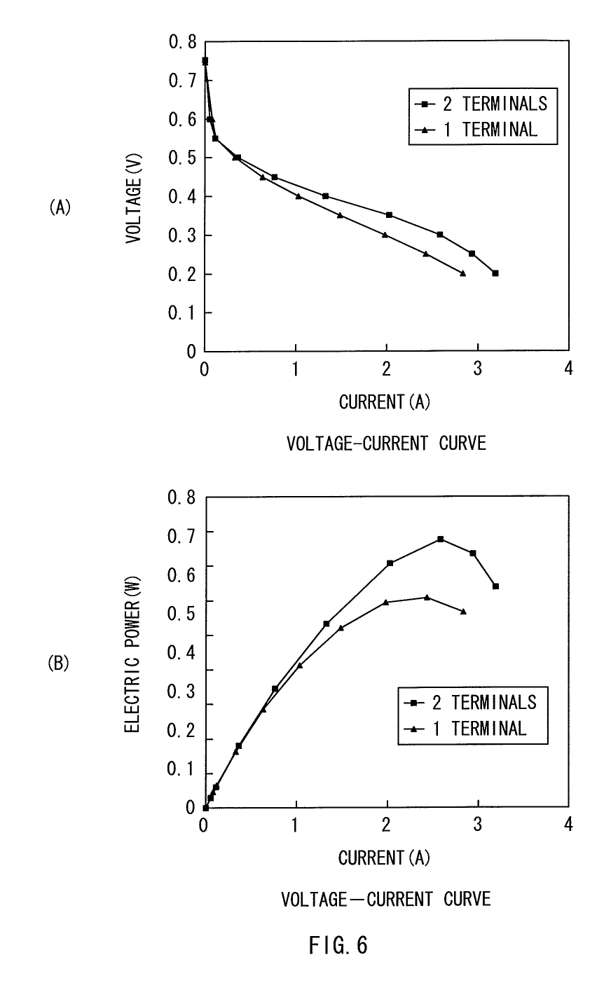

FIG. 6 illustrates (A) voltage-current curves and (B) power-current curves of the fuel cell including two current collector terminals or one current collector terminal in the current collector. From FIG. 6, an improvement in peak output of 33% was seen by providing two current collector terminals in a single current collector. As a reason for this, it is considered that, since the output improvement is in the high current region, as a result of having the current collector terminals in two locations, the path over which the current flows was divided into two and the distance over which the current flows was halved. Thereby, the electrical resistance was significantly reduced.

From the foregoing result, it may be said that the resistance inside the fuel cell is able to be significantly reduced by providing a plurality of current collector terminals in the current collector.

The present disclosure has been described above using the example embodiment, the application example, and the example. However, the present disclosure is not limited to the foregoing example embodiment and the like, and various modifications may be made. For example, according to the foregoing example embodiment and the like, the catalyst layer 13 is provided on only one side of the current collector 11, but the catalyst layer 13 may be provided on both sides thereof

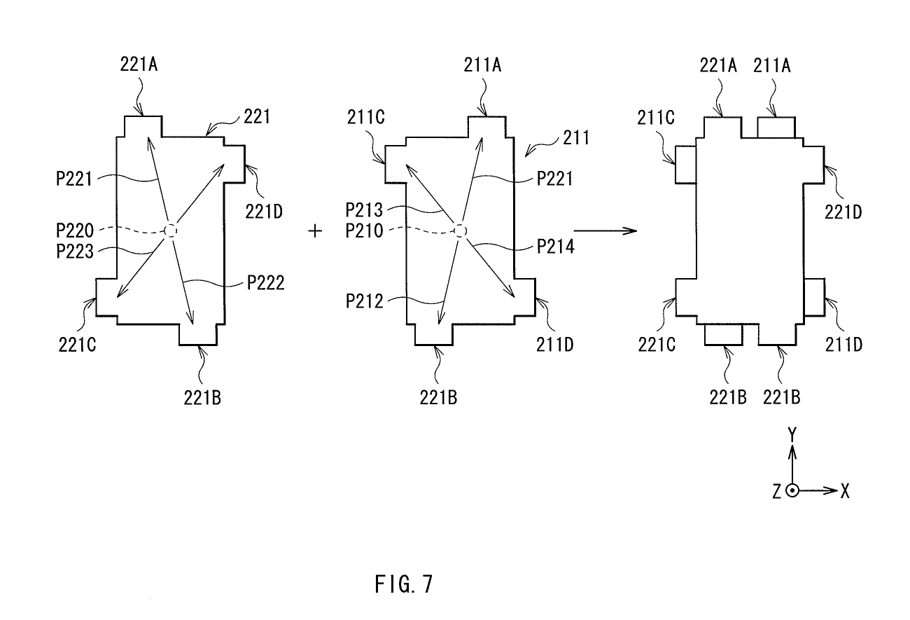

In addition, according to the foregoing example embodiment and the like, the detailed description is given based on the current collector having two terminals and the opposing-corner arrangement. However, the structure is not limited thereto. For example, as illustrated in FIG. 7, a cross-shaped structure may be formed (four current collector terminals). In this case, the path over which the generated current (P210 and P221) flows is divided into four (P211, P212, P213, and P214; and P221, P222, P223, and P224), and the distance over which the current flows is quartered. Thereby, the resistance within the battery is able to be reduced. Further, each current collector terminal is not necessarily arranged in opposing corners.

Further, the structures of the fuel electrode 10, the oxygen electrode 20, the fuel/electrolyte flow path 30, and the air flow path 40 are respectively described in detail. However, other structures or other materials may be used. For example, in addition to that in which the flow path is formed by processing the resin sheet as described according to the foregoing example embodiment, the fuel/electrolyte flow path 30 may be composed of a porous sheet and the like. In addition, in place of the fuel/electrolyte flow path 30, an electrolyte film may be disposed. Further, a carbon material may be used for the current collector 11 and the current collector 21.

Furthermore, the fluid F1 containing the fuel and the electrolytic liquid described according to the foregoing example embodiment and the like is not limited only to that having proton (H⁺) conductivity, such as phosphoric acid or ionic liquid in addition to sulfuric acid, and may be an alkaline electrolytic solution. Further, the fuel F2 described according to the foregoing second example embodiment may be other alcohols, such as ethanol or dimethyl ether, or sugar fuel, in addition to methanol.

Moreover, in the foregoing example embodiment and the like, a case where air is supplied to the oxygen electrode 20 is described. However, oxygen or a gas containing oxygen may be supplied in place of air.

Further, the material and thickness of each element, and the operating conditions of the fuel cell 110 described in the foregoing example embodiment and the like are not limited thereto, and other materials and thicknesses may be used, or other operating conditions may be used.

Furthermore, in the foregoing example embodiment and the like, the description is given using as an example, a direct methanol fuel cell as the fuel cell. However, the fuel cell is not limited thereto, and the present disclosure is applicable to a fuel cell using substances other than liquid fuel, such as hydrogen, as fuel, such as a PEFC (Polymer Electrolyte Fuel Cell), alkaline fuel cell, an enzyme battery using a sugar fuel such as glucose, and the like. Further, in the foregoing example embodiment, a structure is used in which each current collector 11 and 21 of the fuel electrolyte 10 and the oxygen electrolyte 20 has a plurality of terminals. However, a structure may be used in which only either one has a plurality of terminals.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-10. (canceled)

11. A fuel cell comprising:
a fuel electrode including a first current collector;
an oxygen electrode including a second current collector;
an electrolyte flow path provided between the fuel electrode and the oxygen electrode, the electrolyte flow path being configured to distribute an electrolyte; and
a plurality of current collector terminals that are provided in at least one of the first current collector and the second current collector, and project outside.

12. The fuel cell of claim 11, wherein the first current collector and the second current collector each have a rectangular shape.

13. The fuel of claim 12, wherein a pair of current collector terminals are included in opposing-corner positions of the rectangular current collector.

14. The fuel cell of claim 12, wherein:
(a) two pairs of current collector terminals are arranged in opposing corners in four ends of the rectangular current collector;
(b) one pair of current collector terminals projects outside along one edge direction of the current collector; and
(c) another pair of current collector terminals projects outside along another edge direction.

15. The fuel cell of claim 11, wherein the current collector is a plate-shaped or a mesh-shaped member composed of a metal material.

16. The fuel cell of claim 11, wherein the current collector is a plate-shaped or a mesh-shaped member composed of a carbon material.

17. The fuel cell of claim 11, wherein:
(a) a unit cell is structured to include the fuel electrode, the oxygen electrode, and the electrolyte flow path; and
(b) in the unit cell, each current collector terminal in the first current collector and each current collector terminal in the second current collector are oppositely arranged so as not to overlap with each other.

18. The fuel cell of claim 17, wherein:
(a) a plurality of unit cells are provided and stacked along a thickness direction; and
(b) the current collector terminals in the first current collector and the current collector terminals in the second current collector project so as to be oppositely arranged with each other.

19. An electrode comprising:
a current collector having a plurality of current collector terminals, wherein the electrode is used as a fuel electrode or an oxygen electrode of a fuel cell having an electrolyte flow path that is provided between the fuel electrode and the oxygen electrode, and distributes at least an electrolyte

20. An electronic device comprising:
a fuel cell including a fuel electrode including a first current collector, an oxygen electrode including a second current collector, an electrolyte flow path that is provided between the fuel electrode and the oxygen electrode and distributes at least an electrolyte, and a plurality of current collector terminals that are provided in at least one of the first current collector and the second current collector and project outside.
